(19) United States
(12) Patent Application Publication
(10) Pub. No.: US 2014/0278085 A1
(43) Pub. Date: Sep. 18, 2014

(54) DETERMINING AN OPTIMAL VEHICULAR TRANSPORTATION ROUTE

(71) Applicant: INTERNATIONAL BUSINESS MACHINES CORPORATION, Armonk, NY (US)

(72) Inventor: Ying Zuo, San Jose, CA (US)

(73) Assignee: International Business Machines Corporation, Armonk, NY (US)

(21) Appl. No.: 13/840,556

(22) Filed: Mar. 15, 2013

(51) Int. Cl. G01C 21/34

(52) U.S. Cl. CPC G01C 21/34
USPC 701/527

(57) ABSTRACT

Embodiments of the present invention disclose a method, computer program product, and system for determining an optimal vehicular transportation route using location based services. A computing device receives a point of origin and destination. The computing device determines a plurality of vehicular transportation routes between the starting point and destination. The computing device also determines an optimal vehicular transportation route included in the plurality of vehicular transportation routes by comparing two vehicular transportation routes included in the plurality of transportation routes that each have a proprietary point of interest within a predetermined distance. Each vehicular transportation route includes the respective proprietary point of interest. Further, each proprietary point of interest is associated with the computing device.

### FIELD OF THE INVENTION

The present invention relates generally to the field of location based services and more particularly to determining an optimal vehicular transportation route using location based services.

### BACKGROUND OF THE INVENTION

Customers frequently utilize a company's website to help them find the location of the company's physical store or facility (hereinafter “site”). Using such a website, a customer provides point of origin (hereinafter “PO”) information such as a zip code and/or address, and using such information, the website determines the site locations near the PO. Alternatively, the customer provides maximum distance information that reflects the maximum distance from the PO within which the website must search for the desired site location information. The site location information is typically provided in the form of a digital map that represents a particular geographic area, detailing major road arteries and other points of interest.

A website is a set of related web pages containing content such as text, images, sound, video, audio, and animation. A website is hosted on at least one web server, accessible via a network such as the Internet or a private local area network through an Internet address, such as a Uniform Resource Locator. A webpage is a document, typically written in a markup language, such as Hypertext markup Language. A webpage can be accessed using the Hypertext Transfer Protocol (HTTP). A user's application, for example, a web browser, renders the page content according to its HTML markup instructions onto a display.

### SUMMARY

Embodiments of the present invention disclose a method, computer program product, and system for determining an optimal vehicular transportation route using location based services. A computing device receives a point of origin and destination. The computing device determines a plurality of vehicular transportation routes between the starting point and destination. The computing device also determines an optimal vehicular transportation route included in the plurality of vehicular transportation routes by comparing two vehicular transportation routes included in the plurality of transportation routes that each have a proprietary point of interest within a predetermined distance. Each vehicular transportation route includes the respective proprietary point of interest. Further, each proprietary point of interest is associated with the computing device.

### BRIEF DESCRIPTION OF THE SEVERAL VIEWS OF THE DRAWINGS

FIG. 1 is a block diagram illustrating an environment, in accordance with an embodiment of the present invention.

FIG. 2 is a data flow diagram depicting the intercommunications of components included in environment 100 of FIG. 1, in accordance with an embodiment of the present invention.

FIG. 3 is a flowchart depicting the operational steps of a program function, inserted on a web server within the environment of FIG. 1, in accordance with an embodiment of the present invention.

FIG. 4 depicts a block diagram of components of the web server executing the program function, in accordance with an embodiment of the present invention.

### DETAILED DESCRIPTION

It is common for a customer to use a company's website to locate a site location associated with that company. Typically, a customer desires to find a company's site location within a predefined geographic area. However, a customer may desire a vehicular transportation route that is the fastest time-wise, shortest distance-wise, safest, most scenic, most popular, or restricted to major road ways.

Vehicular transportation routes can be determined using route determining algorithms, for example, the Time Interval All Fastest Paths (AllFP) query, Dijktra's shortest path algorithm, and the A* algorithm. Such algorithms can utilize digital maps to determine a route. Digital maps are typically organized as a series of interconnected nodes, which each represent a point of interest (hereinafter “POI”). A POI can be either physical, such as a site location, or navigational, such as an intersection, traffic light, and roundabout. Links between these nodes may include information relevant for a user, for example, the name, address and phone number of the site location. In addition, links may include information associated with determining vehicular transportation routes, such as the distance between the connected two nodes and/or the type of road (motorway, main road, minor road, residential, etc.) the link represents.

For example, to determine the shortest route between a point of origin (hereinafter “PO”) and a destination, a system can use an algorithm that determines all possible routes from one location to another, and for each route, determine the total distance of all links used. Another system can determine a subset of the possible routes using a heuristic. The determined shortest vehicular transportation route is the route that reflects the shortest distance. The fastest route between a PO and a destination, for example, can be determined using knowledge of the speed limit on a particular road way. A plurality of vehicular transportation routes between the PO and the destination is determined and then the times to traverse each vehicular transportation route are determined by dividing the total distance between nodes included therein by the speed limit, and totaling the times. The fastest route can be determined in various ways, such as by comparing two vehicular transportation routes included in the plurality of vehicular transportation routes. The determined vehicular transportation route is subsequently transmitted to the user's computing device for presentation.

Embodiments of the present invention seek to determine an optimal vehicular transportation route from a predefined PO to a predefined destination that includes a site location, such as the location of a bank branch.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by, or in connection with, an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by, or in connection with, an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like, and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

Embodiments of the present invention will now be described in detail with reference to the Figures. FIG. 1 is a block diagram illustrating an environment, generally designated 100, in accordance with one embodiment of the present invention. Environment 100 includes network 150, exemplary information servers 130, client computing device 140, and web server 110. Network 150 can be, for example, a local area network (LAN), a wide area network (WAN) such as the Internet, or a combination of the two, and includes wired, wireless, or fiber optic connections. In general, network 150 can be any combination of connections and protocols that will support communications between, web server 110, exemplary information servers 130, and client computing device 140, in accordance with an embodiment of the invention.

Exemplary information servers 130, client computing device 140, and web server 110 can each be, for example, a mainframe or mini computer, a laptop, tablet, or netbook personal computer (PC), or a desktop computer. In general, exemplary information servers 130, client computing device 140, and web server 110 can be any programmable electronic device capable of supporting the required functionality of an embodiment of the present invention, and as described in further detail with respect to FIG. 4.

Exemplary information servers 130 represents at least one computing device that provides vehicular transportation optimizing information (hereinafter “VTOI”) to a computing device within environment 100, for example, web server 110, in accordance with an embodiment of the present invention. Exemplary information servers 130 are in communication with network 150. Exemplary information servers 130 include exemplary information stores 132. Exemplary information stores 132 include VTOI. In an embodiment, VTOI includes real-time and/or historic vehicular traffic information associated with a geographic area. For example, VTOI can include vehicular traffic information derived from vehicular traffic data that is in the public domain, such as vehicular traffic data generated by a Department of Transportation, or owned by a private entity, such as Google Maps©. In another embodiment, VTOI includes crime information associated with a geographic location. For example, VTOI can include crime information associated with a geographic location derived from a public database, such as the United States Crimes Database. In yet another embodiment, VTOI includes information that reflects popular vehicular transportation routes. For example, VTOI can include popular vehicular transportation routes derived from a social networking application or a periodical publication, such as Popular Mechanics® or Road & Track®. In yet still another embodiment, VTOI includes information that reflects opinions on scenic vehicular transportation routes, for example, opinion derived from a social networking application. In an embodiment, VTOI can include information reflective of road conditions, vehicular traffic volume, vehicular accident locations, and/or street orientations.

Client computing device 140 represents a computing device used by a human user to access information included in a computing device within environment 100, for example, web server 110, in accordance with an embodiment of the present invention. Client computing device 140 is in communication with network 150 and includes web browser 142. Web browser 142 is software that allows a user to retrieve, present, and traverse electronic information resources, such as web pages, images, video, and sound recordings, on the World Wide Web. In particular, web browser 142 allows a user of client computing device 140 to access, via network 150, web server 110 and information included therein.

Web server 110 represents a computing device that hosts a company's website within environment 100, in accordance with an embodiment of the present invention. Web server 110 may include internal and external hardware components, as depicted and described in further detail with respect to FIG. 4. Web server 110 is in communication with network 150. Web server 110 includes website program 112 and program function 120. Web server 110 is a computing device that delivers, via network 150, content such as text, images, sound, video, audio, and animation associated with website program 112 for example, to client computing device 140.

Website program 112 represents the website of a company with site locations, in accordance with an embodiment of the present invention. Website program 112 is in communication with program function 120. Website program 112 includes website information store 114, which is an information repository that includes content associated with the company. Website program 112 also includes site location information store 116, which is an information repository that includes geographic information of the site locations. Website program 112 further includes map information store 118, which is an information repository that includes navigational information of an area, such as a road map associated with the site locations. In an embodiment, the navigational information includes two-dimensional and/or three dimensional navigational information.

Website program 112 transmits, via network 150, geographic information concerning the company to a computing device included in environment 100, for example, client computing device 140. Website program 112 also transmits, via network 150, navigational information associated with the company to client computing device 140. Website program 112 can determine and/or transmit, via network 150, navigational information associated with a site location to a computing device within environment 100, such as client computing device 140.

Program function 120 is software that determines an optimal vehicular transportation route, in accordance with an embodiment of the present invention. Program function 120 is in communication with website program 112. Program function 120 can, via web server 110, access exemplary information stores 132 included in exemplary information servers 130. Program function 120 can generate an optimal vehicular transportation route that includes a PO, destination, and site location. Program function 120 can, via website program 112, access website information store 114, site location information store 116, and/or map information store 118. In various embodiments, optimal vehicular transportation route is the fastest, shortest, simplest, most scenic, and/or safest vehicular transportation route.

Embodiments of the present invention generate an optimal vehicular transportation route from a PO to a destination that includes a company's physical site location.

Concepts introduced in the following discussion of FIG. 2 will be used further in the discussion of FIG. 3 in the context of environment 100 of FIG. 1. Specifically, FIG. 2 illustrates various transmissions that result during the execution of an embodiment of the present invention wherein a customer desires to travel from geographic location X (hereinafter “GLX”) to geographic location Y (hereinafter “GLY”) and stop at a site location of company Z, geographic location Z (hereinafter “GLZ”), along the way in the least amount of time. Program function 120 can determine an optimized vehicular transportation route that includes GLX, GLY, and GLZ by utilizing VTOI.

FIG. 2 is a depiction of various request/response cycles (cycles) involving the computing devices of FIG. 1. In particular, cycle 2A represents a request/response cycle between client computing device 140 to web server 110. Cycle 2A initiates when a user of client computing device 140 accesses, via network 150, website program 112 on web server 110, which hosts a website associated with company Z, and inputs GLX as the PO, GLY as the destination, and fastest path as the desired optimization. Program function 120 detects the input of GLX and GLY to website program 112 by client computing device 140 and the customer's desire for a time optimized vehicular transportation route involving GLX, GLY, and a GLZ.

Cycle 2A overlaps with cycle 2B. Cycle 2B represents a request/response cycle that includes web server 110 and exemplary information servers 130. Cycle 2B initiates when program function 120 requests VTOI associated with a fastest path solution from exemplary information stores 132 included on exemplary information servers 130. For example, VTOI can include real-time and/or historic vehicular traffic information of a geographic area that includes GLX, GLY, and/or GLZ. Cycle 2B concludes when exemplary information servers 130 transmit, via network 150, the requested VTOI to program function 120.

In response, program function 120, utilizing the received VTOI, determines a desired optimized vehicular transportation route that includes GLX, GLY, and GLZ. For example, program function 120, via website program 112, accesses site location information store 116 and map information store 118 and determines a plurality of vehicular transportation routes from GLX to GLY that include a GLZ. In one embodiment, the plurality of vehicular transportation routes includes all possible routes. In another embodiment, the plurality of vehicular transportation routes includes a subset of the possible routes based on a heuristic. For example, the heuristic can reduce the number of possible routes by considering only those that exist entirely within a bounding square, bounding circle, or other bounding shape or volume around GLX, GLY, and GLZ. Program function 120, utilizing the real-time and/or historic vehicular traffic information included in the received VTOI, determines the shortest vehicular transportation route included in the plurality of vehicular transportation routes, for example, using a method disclosed above. In an embodiment of the present invention, an optimal vehicular transportation route can be determined by comparing two vehicular transportation routes included in the plurality of transportation routes that each have a proprietary point of interest (GLZ) within a predetermined distance. In another embodiment, the two vehicular transportation routes are summarized by time units and/or distance.

Cycle 2A concludes when program function 120 transmits, via network 150, the determined vehicular traffic route to client computing device 140 for display.

FIG. 3 is a flowchart depicting the operational steps of program function 120, inserted on web server 110 within environment 100 of FIG. 1, in accordance with an embodiment of the present invention. Program function 120 receives vehicular point of origin information (step 300). Program function 120 receives vehicular destination point information (step 310). Program function 120 receives VTOI (step 320). In one embodiment, program function 120 determines all possible routes between the PO and destination that include a site location (step 330). In another embodiment, program function 120 determines a subset of the possible routes based on a heuristic. Program function 120 determines an optimal vehicular transportation route from the routes determined in step 330 (step 340).

FIG. 4 depicts a block diagram of components of web server 110, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Web server 110 includes communications fabric 402, which provides communications between computer processor(s) 404, memory 406, persistent storage 408, communications unit 410, and input/output (110) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 414 and cache memory 416. In general, memory 406 can include any suitable volatile or non-volatile computer-readable storage media.

Website program 112, program function 120, web site information store 114, site location information store 116, and map information store 118 are stored in persistent storage 408 for execution and/or access by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in these examples, provides for communications with other data processing systems or devices, including exemplary information servers 130 and client computing device 140. In these examples, communications unit 410 includes one or more network interface cards. Communications unit 410 may provide communications through the use of either or both physical and wireless communications links. Website program 112 and program function 120 may be downloaded to persistent storage 408 through communications unit 410.

I/O interface(s) 412 allows for input and output of data with other devices that may be connected to web server 110. For example, I/O interface 412 may provide a connection to external devices 418 such as a keyboard, keypad, a touch screen, and/or some other suitable input device. External devices 418 can also include portable computer-readable storage media such as, for example, thumb drives, portable optical or magnetic disks, and memory cards. Software and data used to practice embodiments of the present invention, e.g., program function 120, can be stored on such portable computer-readable storage media and can be loaded onto persistent storage 408 via I/O interface(s) 412. I/O interface(s) 412 also connects to a display 420. Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for determining an optimal vehicular transportation route, the method comprising:
receiving, by a computing device, a point of origin and destination;
determining a plurality of vehicular transportation routes between the point of origin and destination;
determining an optimal vehicular transportation route included in the plurality of vehicular transportation routes by comparing two vehicular transportation routes included in the plurality of transportation routes that each have a proprietary point of interest within a predetermined distance;
wherein each vehicular transportation route includes a respective proprietary point of interest; and
wherein each proprietary point of interest is associated with the computing device.

2. The method of claim 1, wherein the optimal vehicular transportation route is determined using one of the following:
a fastest path algorithm;
a shortest path algorithm;
a simplest path algorithm;
a most scenic path algorithm; and
a safest path algorithm.

3. The method of claim 1, wherein the two vehicular transportation routes are summarized by time units.

4. The method of claim 1, wherein the two vehicular transportation routes are summarized by distance.

5. The method of claim 1, wherein the determining an optimal vehicular transportation route includes utilizing real-time and/or historic vehicular traffic information associated with the point of origin and/or destination.

6. The method of claim 1, wherein the determining an optimal vehicular transportation route includes utilizing crime information associated with the point of origin and/or destination.

7. A computer program product for determining an optimal vehicular transportation route, the computer program product comprising:
one or more computer-readable storage media and program instructions stored on the one or more computer-readable storage media, the program instructions comprising:
program instructions to receive a point of origin and destination;
program instructions to determine a plurality of vehicular transportation routes between the point of origin and destination; and
program instructions to determine an optimal vehicular transportation route included in the plurality of vehicular transportation routes by comparing two vehicular transportation routes included in the plurality of transportation routes that each have a proprietary point of interest within a predetermined distance, wherein each vehicular transportation route includes a respective proprietary point of interest, and wherein each proprietary point of interest is associated with a computing device configured to execute the computer program product.

8. The computer program product of claim 7, wherein the optimal vehicular transportation route is determined using one of the following:
a fastest path algorithm;
a shortest path algorithm;
a simplest path algorithm;
a most scenic path algorithm; and
a safest path algorithm.

9. The computer program product of claim 7, wherein the two vehicular transportation routes are summarized by time units.

10. The computer program product of claim 7, wherein the two vehicular transportation routes are summarized by distance.

11. The computer program product of claim 7, wherein the determining an optimal vehicular transportation route includes utilizing real-time and/or historic vehicular traffic information associated with the point of origin and/or destination.

12. The computer program product of claim 7, wherein the determining an optimal vehicular transportation route includes utilizing crime information associated with the starting point and/or destination.

13. A computer system for determining an optimal vehicular transportation route, the computer system comprising:
one or more computer processors;
one or more computer-readable storage media; and
program instructions stored on the computer-readable storage media for execution by at least one of the one or more processors, the program instructions comprising:
program instructions to receive a point of origin and destination;
program instructions to determine a plurality of vehicular transportation routes between the point of origin and destination; and
program instructions to determine an optimal vehicular transportation route included in the plurality of vehicular transportation routes by comparing two vehicular transportation routes included in the plurality of transportation routes that each have a proprietary point of interest within a predetermined distance, wherein each vehicular transportation route includes a respective proprietary point of interest, and wherein each proprietary point of interest is associated with the at least one of the one or more processors.

14. The computer system of claim 13, wherein the optimal vehicular transportation route is determined using one of the following:
a fastest path algorithm;
a shortest path algorithm;
a simplest path algorithm;
a most scenic path algorithm; and
a safest path algorithm.

15. The computer system of claim 13, wherein the two vehicular transportation routes are summarized by time units.

16. The computer system of claim 13, wherein the two vehicular transportation routes are summarized by distance.

17. The computer system of claim 13, wherein the determining an optimal vehicular transportation route includes utilizing real-time and/or historic vehicular traffic information associated with the point of origin and/or destination.

18. The computer system of claim 13, wherein the determining an optimal vehicular transportation route includes utilizing crime information associated with the point of origin and/or destination.
